(19) United States
(12) Patent Application Publication
(10) Pub. No.: US 2004/0088270 A1
(43) Pub. Date: May 6, 2004

(54) Postage indicia for product registration cards

(76) Inventor: Susan M.F. Davis, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/284,760

(22) Filed: Oct. 31, 2002

(51) Int. Cl. G06F 17/00; G07B 17/02

(52) U.S. Cl. 705/408; 705/401

(57) ABSTRACT

A system prints postage indicia for a product registration card at a location of a transaction for a product. The system comprises a processing system and a postage printing device. The processing system receives transaction information indicating the transaction for the product. The processing system processes the transaction information to generate a print instruction to print the postage indicia for the product registration card. The postage printing device then prints the postage indicia for the product registration card based on the print instruction.

### BACKGROUND OF THE INVENTION

1. Field of the Invention

The invention is related to the field of mailing systems, and in particular, to systems, methods, and software products for printing postage indicia for product registration cards.

2. Statement of the Problem

Capturing consumer information for marketing purposes is a critical component of any business. Consumer information such as age, sex, household income, point of purchase, and outside interests provide a better understanding for targeted marketing campaigns. One method of capturing this consumer information is the submission of product registration cards by consumers. After purchasing an item, a consumer fills out a product registration card with their name, address, and answers to a series of questions. One problem with these product registration cards is the consumer's time and effort in filling in redundant information that could be captured at the point of sale.

The consumer then mails the product registration card back to the manufacturer. There are numerous methods to mail the product registration card with postage. One method is the manufacturer does not supply any postage. The manufacturer provides an area in the upper right hand corner of the front of the product registration card for the consumer to affix the proper postage. One problem is the consumer has to pay for postage that primarily benefits the manufacturer in gathering marketing information. The consumer may feel disinclined to pay for postage after already paying to purchase the item, which results in consumers not submitting the product registration cards.

Another method is when the manufacturer affixes postage to the product registration card and places the card in the product packaging. One problem is when the postage rate changes during the period when the manufacturer has already affixed the postage and the mailing of the product registration card. The product registration card has an improper amount of postage and does not get returned to the manufacturer.

Another problem is the inefficient use of postage. The manufacturer is affixing postage to product registration cards with products that may not be sold or on cards that consumers may never return and thus an unnecessary lost business expense.

Another method is when the manufacturer pays for the postage by using a bulk mail permit. The product registration card contains a permit number, the city and state of the post office of the bulk mail permit, and a message stating that no postage is necessary if mailed in the United States. Unfortunately, the manufacturer obtains these bulk mail permits for a finite number of items such as two hundred. Once again, there is an inefficient use of postage with this method. If the number of product registration cards mailed is less than the finite number for the bulk mail permit, the manufacturer has paid a postage amount that exceeds the proper postage amount needed.

Thus, there is a need to pay for postage on product registration cards that encourages the submission of the product registration cards and efficiently uses an appropriate amount of postage for the product registration cards.

### SUMMARY OF THE SOLUTION

The invention helps to solve the above problems with methods, systems, and software products to print postage indicia for a product registration card at a location of a transaction for a product. Businesses efficiently pay less for postage by printing the postage indicia for the product registration cards at the location of the transaction. Otherwise, the business has to pay extra for bulk mailing or for stamped cards that may not be used.

A system prints postage indicia for a product registration card at a location of a transaction for a product. The system comprises a processing system and a postage printing device. The processing system receives transaction information indicating the transaction for the product. The processing system processes the transaction information to generate a print instruction to print the postage indicia for the product registration card. The postage printing device then prints the postage indicia for the product registration card based on the print instruction.

In some embodiments, the postage printing device affixes the postage indicia to the product registration card. In other embodiments, the processing system accumulates a postage charge for the postage indicia. In some embodiments, the postage printing device prints the transaction information on the product registration card. In some embodiments, the transaction information is a serial number of the product, a product description, a date of the transaction, or a point of sale location.

### DESCRIPTION OF THE DRAWINGS

The same reference number represents the same element on all drawings.

FIG. 1 is a block diagram for a product transaction location in an example of the invention.

FIG. 2 is a flow chart for the postage printing system in an example of the invention.

FIG. 3 is a block diagram of the processing system in an example of the invention.

FIG. 4 is a flow chart for a product transaction system and a postage printing system in an example of the invention.

### DETAILED DESCRIPTION OF THE INVENTION

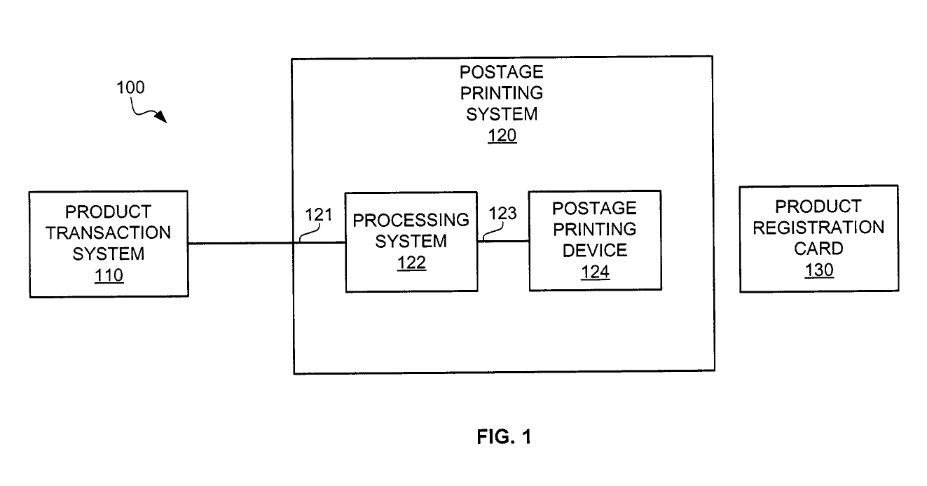

FIGS. 1-4 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Product Transaction System and Postage Printing System—FIGS. 1-4

FIG. 1 depicts a block diagram for a product transaction location 100 in an example of the invention. The product transaction location 100 comprises a product transaction system 110, a postage printing system 120, and a product registration card 130. The postage printing system 120 comprises a processing system 122 and a postage printing device 124. The product transaction system 110 is connected to the processing system 122 via a link 121. The processing system 122 is connected to the postage printing device 124 via a link 123.

The product transaction system 110 includes any system, device, or group of devices configured to transmit transaction information indicating a transaction for a product. Some examples of the product transaction system 110 are a cash register and a point of sale terminal.

A transaction includes any activity that a product is exchanged for financial consideration. Some examples of transaction are purchasing, renting, and leasing.

The transaction information includes any information related to the transaction for a product. Some examples of transaction information are a serial number, a product description, a customer name, a customer address, and a point of sale location. In one embodiment, the transaction information includes a mere notice that a transaction has occurred.

The postage printing system 120 includes any system, device, or group of devices configured to receive transaction information indicating the transaction for the product, process the transaction information to generate a print instruction to print the postage indicia for the product registration card 130, and print the postage indicia for the product registration card 130 based on the print instruction. In some embodiments, the postage printing system 120 is combined into one system with the product transaction system 110. The print instruction includes any message, instruction, or signal that indicates to print the postage indicia for the product registration card 130. Postage indicia includes any marking, stamp, or writing that indicates a payment for a delivery. In one example, postage indicia is printed with a fluorescent ink and provides information such as mailing date, amount of postage, licensing post office city, licensing post office state, meter manufacturer, and meter number.

The product registration card 130 is any letter, card, postcard, paper, or other suitable media that contains information for registering a product with a company, business, or organization. One example of the product registration card 130 includes spaces for a customer name, customer address, product serial number, and answers to a series of questions related to the product, customer, or transaction.

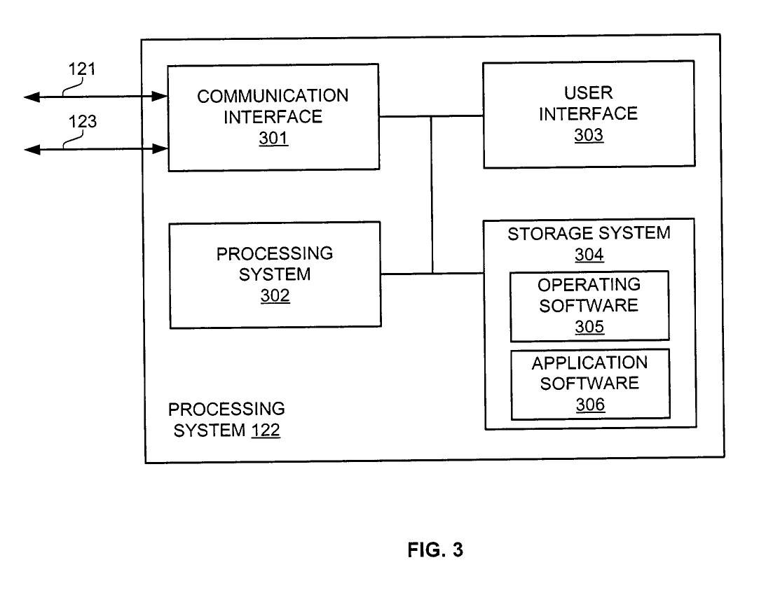

The processing system 122 includes any system, device, or group of devices configured to receive transaction information indicating the transaction for the product and process the transaction information to generate a print instruction to print the postage indicia for the product registration card 130. One example of the processing system 122 is depicted and discussed in FIG. 3 below.

The postage printing device 124 includes any system, device, or group of devices configured to print the postage indicia for the product registration card 130 based on the print instruction.

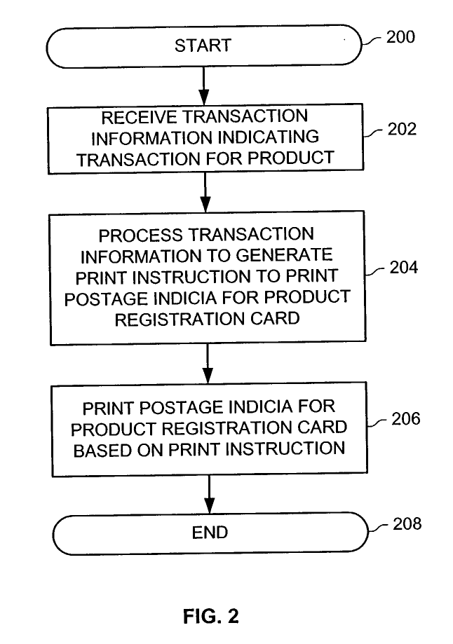

FIG. 2 depicts a flow chart for the postage printing system 120 in an example of the invention. FIG. 2 begins in step 200. In step 202, the processing system 122 receives transaction information indicating the transaction for the product. In step 204, the processing system 122 processes the transaction information to generate a print instruction to print the postage indicia for the product registration card 130. In step 206, the postage printing device 124 prints the postage indicia for the product registration card 130 based on the print instruction. FIG. 2 ends in step 208.

FIG. 3 depicts a block diagram of the processing system 122 in an example of the invention. The postage printing system 122 includes communication interface 301, processing system 302, user interface 303, and storage system 304. Storage system 304 stores operating software 305 and application software 306. Processing system 302 is linked to communication interface 301, user interface 303, and storage system 304. Processing system 122 could be comprised of a programmed general-purpose computer, although those skilled in the art will appreciate that programmable or special purpose circuitry and equipment may be used. Processing system 122 may use a client server architecture where operations are distributed among a server system and client devices that together comprise elements 301-306.

Communication interface 301 could comprise a network interface card, modem, port, or some other communication device. Communication interface 301 interfaces between the processing system 302 and the product transaction system 110 via the link 121 and interfaces between the processing system 302 and the postage printing device 124 via the link 123. Communication interface 301 may be distributed among multiple communication devices. Processing system 302 could comprise a computer microprocessor, logic circuit, or some other processing device. Processing system 302 may be distributed among multiple processing devices.

User interface 303 could comprise a keyboard, mouse, voice recognition interface, microphone and speakers, graphical display, touch screen, or some similar other type of user device.

Storage system 304 could comprise a disk, tape, integrated circuit, server, or some other similar memory device. Storage system 304 may be distributed among multiple memory devices.

Processing system 302 retrieves and executes operating software 305 and application software 306 from storage system 304. Operating software 305 may comprise an operating system, utilities, drivers, networking software, and other software typically loaded onto a general-purpose computer.

Application software 306 could comprise an application program, firmware, or some other form of machine-readable processing instructions. When executed by processing system 302, application software 306 directs processing system 302 to receive transaction information indicating the transaction for the product and process the transaction information to generate a print instruction to print the postage indicia for the product registration card.

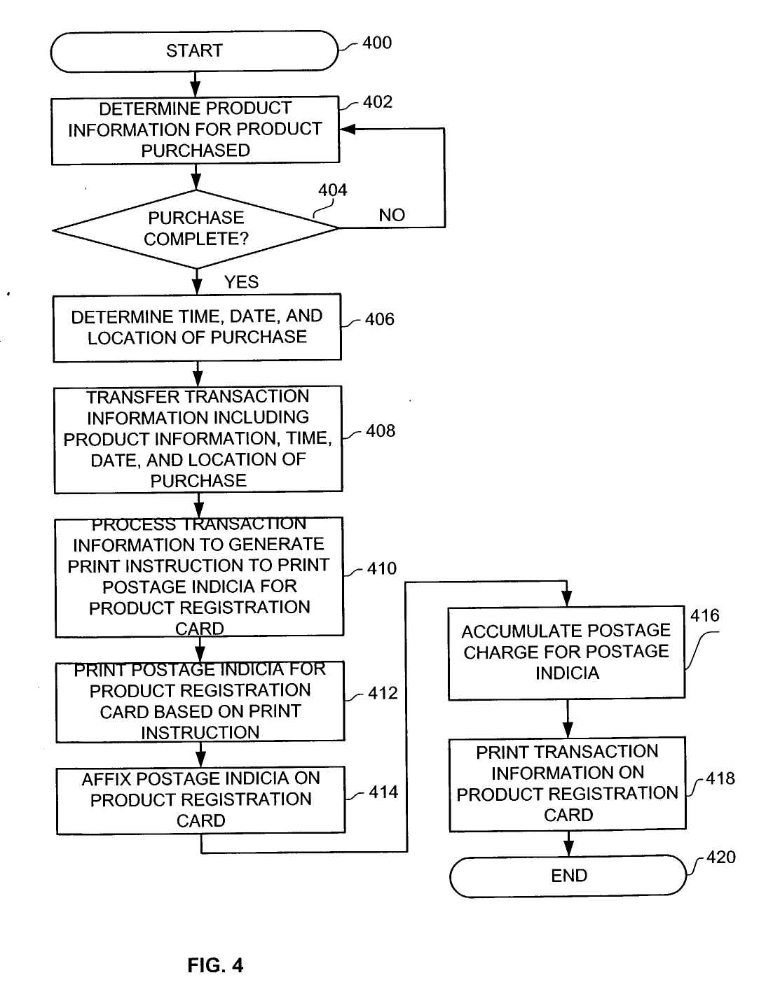

FIG. 4 is a flow chart for the product transaction system 110 and the postage printing system 120 in an example of the invention. FIG. 4 begins in step 400. In step 402, the product transaction system 110 determines the product information for the product being purchased. In one embodiment, the product transaction system 110 queries a database containing product information. In step 404, the product transaction system 110 determines whether the purchase has been completed. If the purchase is not completed, the product transaction system 110 returns to step 402.

If the purchase is completed, the product transaction system 110 determines the time, date, and location of purchase in step 406.

In step 408, the product transaction system 110 transfers the transaction information including the product information, time, date, and location of purchase to the postage printing system 120.

The postage printing system 120 then processes the transaction information to generate the print instruction to print postage indicia for the product registration card 130 in step 410.

In step 412, the postage printing system 120 prints the postage indicia for the product registration card 130 based on the print instruction.

In step 414, the postage printing system 120 affixes the postage indicia on the product registration card 130.

In step 416, the postage printing system 120 accumulates a postage charge for the postage indicia for billing purposes. The postage charges can then be billed to the addressee such as a manufacturing company on a monthly or other time period basis.

In step 418, the postage printing system 120 prints the transaction information on the product registration card 130. FIG. 4 ends in step 420.

Businesses efficiently pay less for postage by printing the postage indicia for the product registration cards at location of the transaction. Otherwise, a business has to pay extra for bulk mailing or for stamped cards that may not be used. Businesses also have the assurance that proper postage is on the product registration card compared to when no postage is applied to the product registration card. In some embodiments, the printing of transaction information on the product registration card reduces the redundancy of filling out the product registration card, which improves the return rate for the product registration cards.

The above-described elements can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor, and storage media.

1. A method of printing postage indicia for a product registration card at a location of a transaction for a product, the method comprising:
receiving transaction information indicating the transaction for the product;
processing the transaction information to generate a print instruction to print the postage indicia for the product registration card; and
printing the postage indicia for the product registration card based on the print instruction.

2. The method of claim 1 further comprising affixing the postage indicia to the product registration card.

3. The method of claim 1 further comprising accumulating a postage charge for the postage indicia.

4. The method of claim 1 further comprising printing the transaction information on the product registration card.

5. The method of claim 1 wherein the transaction information comprises a serial number of the product.

6. The method of claim 1 wherein the transaction information comprises a product description.

7. The method of claim 1 wherein the transaction information comprises a date of the transaction.

8. The method of claim 1 wherein the transaction information comprises a point of sale location.

9. A system for printing postage indicia for a product registration card at a location of a transaction for a product, the system comprising:
a processing system configured to receive transaction information indicating the transaction for the product and process the transaction information to generate a print instruction to print the postage indicia for the product registration card; and
a postage printing device connected to the processing system and configured to print the postage indicia for the product registration card based on the print instruction.

10. The system of claim 9 wherein the postage printing device is configured to affix the postage indicia to the product registration card.

11. The system of claim 9 wherein the processing system is configured to accumulate a postage charge for the postage indicia.

12. The system of claim 9 wherein the postage printing device is configured to print the transaction information on the product registration card.

13. The system of claim 9 wherein the transaction information comprises a serial number of the product.

14. The system of claim 9 wherein the transaction information comprises a product description.

15. The system of claim 9 wherein the transaction information comprises a date of the transaction.

16. The system of claim 9 wherein the transaction information comprises a point of sale location.

17. A software product for printing postage indicia for a product registration card at a location of a transaction for a product, the software product comprising:
application software operational when executed by a processing system to direct the processing system to receive transaction information indicating the transaction for the product and process the transaction information to generate a print instruction to print the postage indicia for the product registration card; and
a storage system operational to store the application software.

18. The software product of claim 17 wherein the application software is operational when executed by the processing system to direct the processing system to accumulate a postage charge for the postage indicia.

19. The software product of claim 17 wherein the transaction information comprises a date of the transaction.

20. The software product of claim 17 wherein the transaction information comprises a point of sale location.
